(19) United States
(12) Patent Application Publication
(10) Pub. No.: US 2010/0315661 A1
(43) Pub. Date: Dec. 16, 2010

(54) INFORMATION PROCESSING APPARATUS AND CONTROL METHOD THEREFOR

(75) Inventor: Yukimasa Sato, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/796,995

(22) Filed: Jun. 9, 2010

(30) Foreign Application Priority Data
Jun. 12, 2009 (JP) 2009-141386

(51) Int. Cl. G06F 15/00

(52) U.S. Cl. 358/1.9

(57) ABSTRACT

A method for controlling an information processing apparatus is provided, which can easily perform not only print setting but also installation of a printer driver during creation of a hot folder. The hot folder can be easily created by automatically installing the printer driver and setting the printer driver based on an operation of copying a template of a hot folder to a PC.

### BACKGROUND OF THE INVENTION

1. Field of the Invention

The present invention relates to an information processing apparatus having a hot folder loaded thereon, which transmits print data to a printing device by storing the print data in the hot folder serving as a storage area of the information processing apparatus. In particular, the invention relates to a hot folder creation method in the information processing apparatus, a program for creating a hot folder in the information processing apparatus, and the information processing apparatus in which the hot folder is created.

2. Description of the Related Art

There is conventionally a system referred to as a hot folder used for transferring print data from a PC to a printing device or a printing server to print the data.

The system activates a management task for monitoring, at constant intervals, contents of a folder which is a storage area registered in a host computer. When a user stores print data in the folder by dragging and dropping, the management task detects the storage of the data in the folder. The management task processes the print data based on setting which has been registered in association with the hot folder. The setting associated with the hot folder is designation of a printing device of a transfer destination or print setting of the printing device. The print data is transferred to an image processing apparatus (printing device) based on the setting associated with the hot folder, and printed as output based on the setting. More specifically, when a document is stored in the hot folder, the data which is processed according to the setting associating with the hot folder for the document is transmitted as print data to the printing device.

There is a method which recognizes storage of data (document file) in the hot folder as an event, and transfers the stored data to the image processing apparatus. In this case, the document stored in the hot folder is not subjected to any processing. The document and print setting associated with the hot folder are transmitted together to the printing device.

The hot folder function conventionally deals with page-description language (PDL) data or image data which the printing device can analyze without using any driver.

An operation can be performed, which causes an application, a printer driver, and the hot folder to cooperate with one another and transmits print data converted into PDL by the application and the printer driver to the printing device by using the hot folder.

Japanese Patent Application Laid-Open No. 2005-166008 discusses a technology which can easily create a hot folder, prevent a storing mistake of a data file in the hot folder, and easily determine each processing status of a plurality of hot folders. Japanese Patent Application Laid-Open No. 2001-337801 discusses a technology which generates a printer folder (equivalent to hot folder) corresponding to a printer by a personal computer. The technology generates a print condition folder based on a printer function in the printer folder. When a user stores a file in the print condition folder, the file is printed by a corresponding printer under a corresponding print condition.

Japanese Patent Application Laid-Open No. 10-326167 discusses a print system which stores a setting value set once on a printer driver during document printing, and can use the stored setting value for subsequent document printing.

Japanese Patent Application Laid-Open No. 2003-91385 discusses a group printer driver which enables a client computer to provide an interface as one printer driver by comprehensively controlling a plurality of registered printer drivers.

### SUMMARY OF THE INVENTION

The present invention is directed to a method for controlling an information processing apparatus, which can not only easily perform print setting but also installation of a printer driver during creation of a hot folder. According to the present invention, the hot folder can be easily created by automatically installing the printer driver and setting the printer driver in an operation of copying a template folder of the hot folder to a personal computer (PC).

According to an aspect of the present invention, an information processing apparatus includes a reference unit configured to refer to a template of a hot folder of an external storage device which stores the template of the hot folder, an acquisition unit configured to acquire, based on the reference by the reference unit, the template including a folder attribute from the external storage device for the information processing apparatus, and a generation unit configured to generate, after the acquisition unit has acquired the template for the information processing apparatus, a hot folder for the information processing apparatus. In this case, when the generation unit generates the hot folder, the generation unit generates an attribute of the hot folder corresponding to the folder attribute of the template, and sets up a printer driver in the information processing apparatus based on the attribute of the hot folder.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a conceptual diagram of the present invention.

FIG. 2 is a block diagram schematically illustrating a configuration of a control unit of a multifunction peripheral (MFP) illustrated in FIG. 1.

FIGS. 3A and 3B respectively illustrate a template of a hot folder and attribute information of the hot folder according to the present invention.

FIG. 4 is a flowchart illustrating a generation process of the hot folder according to the present invention.

FIG. 5 is a flowchart illustrating a process of print processing when print data is stored in the hot folder according to the present invention.

FIG. 6 is a conceptual diagram when the template of the hot folder stored in an image processing apparatus is copied to a PC to create a hot folder according to the present invention.

FIG. 7 is a conceptual diagram when there is information indicating another storage destination in a storage destination of a driver described in the attribute information of the hot folder according to the present invention.

FIG. 8 is a flowchart illustrating an operation of initialization processing when the template of the hot folder is copied according to the present invention.

### DESCRIPTION OF THE EMBODIMENTS

Various exemplary embodiments, features, and aspects of the invention will be described in detail below with reference to the drawings.

In a conventional hot folder, when a new hot folder is created, a printing device must be set, and an IP address or a port must be set. In a hot folder corresponding to an application, an associating printer driver must be set, which prolongs setting time.

In description below, unless otherwise specified, common or similar portions of exemplary embodiments are denoted by similar reference numerals to avoid repetition.

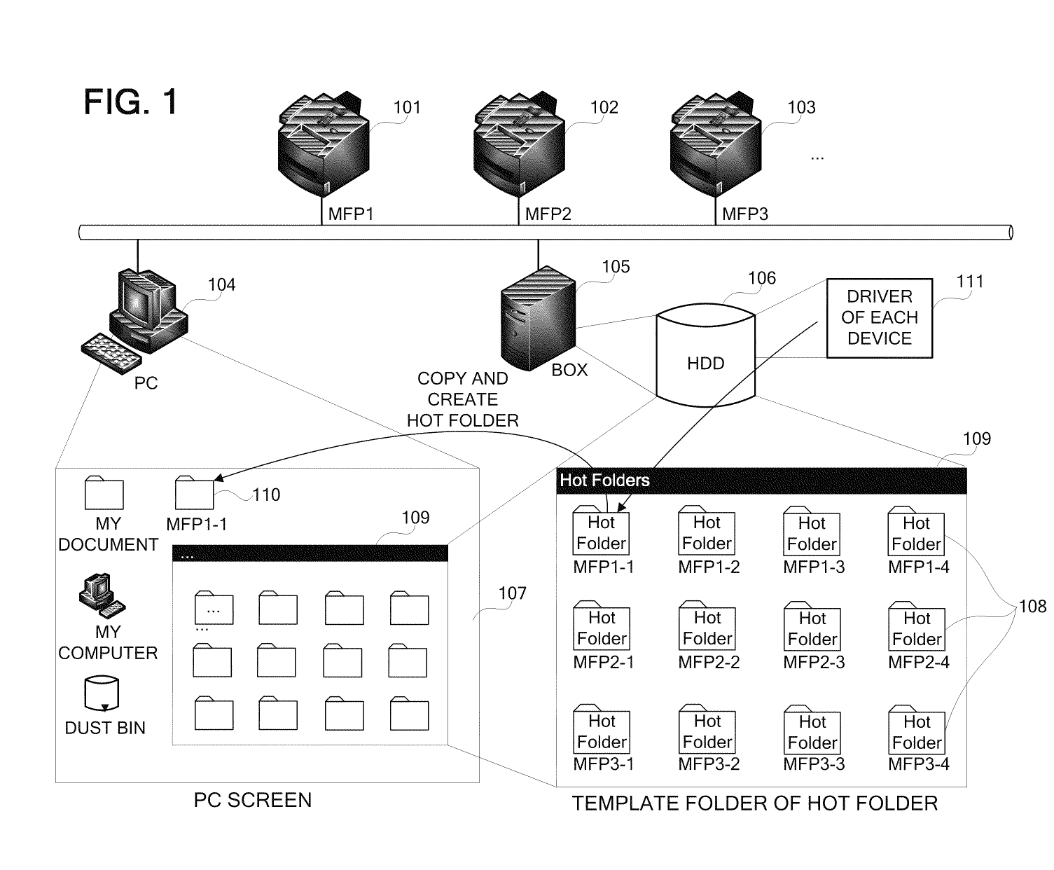

A first exemplary embodiment will be described. FIG. 1 is a conceptual diagram of an image processing system according to the present invention. Each of a MFP1, MFP2, and MFP3 (101, 102, and 103) is a multifunctional printing device having copy, printer, transmission (FAX, e-mail, and file transfer), and BOX functions. The printing device prints image data generated based on print data, on a paper medium, and functions as an image processing apparatus.

A host computer 104 is a personal computer used by a user during printing. The host computer 104 has a hot folder function, and the hot folder checks data within a folder at constant intervals. If there is stored PDL data, the host computer 104 transmits the data to a printing device corresponding to setting associated with the hot folder. More specifically, when PDL data is stored in the hot folder, the host computer 104 transmits data obtained by processing the PDL data based on the setting associated with the hot folder as print data to the printing device.

The PDL data stored in the hot folder may not be subjected to any processing, but the PDL data and print setting associated with the hot folder may be transmitted together to the printing device. In place of the PDL data, a document may be stored in the hot folder.

A file server 105 is shared among the printing devices, and referred to as a BOX in the present invention. The BOX (filer server) 105 has a BOX function of storing the PDL data in a hard disk. The BOX 105 can be referred to from the printing devices (101, 102, and 103), and the PDL data referred to can be printed in the printing devices. The PC 104 and the BOX 105 can include general-purpose information processing apparatus such as a personal computer and a server computer.

The PC 104 can refer to a file of the BOX 105, and to a template folder of a hot folder in the present invention. More specifically, the PC 104 can refer to the BOX 105 as an external storage device. In addition, the BOX 105 stores printer drivers corresponding to various PDL's (PCL, and PostScript) of the printing devices in the hard disk. The template folder of the hot folder will be described below.

The hard disk (HDD) 106 is included in the BOX (file server) 105. Storage areas 111 store the printer drivers of the MFP's (101, 102, and 103) stored in the hard disk 106 of the BOX 105. The printer drivers stored in the storage areas 111 are downloaded for installation during creation of a hot folder, which will be described in detail below.

A PC screen 107 is displayed on a display of the PC 104. A template folder 108 is a conceptual diagram illustrating a template folder of a hot folder stored in a folder 109 of the hard disk 106 of the BOX 105.

The folder 109 is a conceptual diagram illustrating folders storing various template folders 108 of the hot folder corresponding to the MFP's (101, 102, and 103) stored in the hard disk 106 of the BOX 105. When the folder 109 is referred to from the PC 104 and viewed on the PC screen 107, the template folders are displayed as being stored in the folder 109 in a folder form.

In the present invention, a user copies (acquires) the template folder 108 referred to via the PC 104, from the BOX 105 into the PC 104 by dragging and dropping on the PC screen 107, and creates a hot folder 110 with the PC 104.

An (registration) operation of hot folder creation of FIG. 1 will be described briefly. The folder 109 of the template folder 108 of the host folder of the BOX 105 can be referred to as a shared folder from the PC 104 via a network. The template folder 108 of the hot folder for the MFP1 (101) of the BOX 105 is copied (acquired) to the PC 104 via, for example, an explorer of Windows (registered trademark). Thus, for example, a hot folder for the MFP1 (101) is created on a desk top of the PC 104. During copying of the template folder 108, information of a printer driver corresponding to the folder is read, and the driver is installed in the PC 104. Individual print setting is provided for each template folder, and the hot folder 110 of the PC 104 applies the print setting of the template folder to the printer driver. By simply performing dragging and dropping to store print data (document file) in the hot folder created by the PC 104, printing is executed based on the print setting associated with the hot folder. The feature of the present invention has been outlined. Relevant components will be described in detail below referring to the drawings.

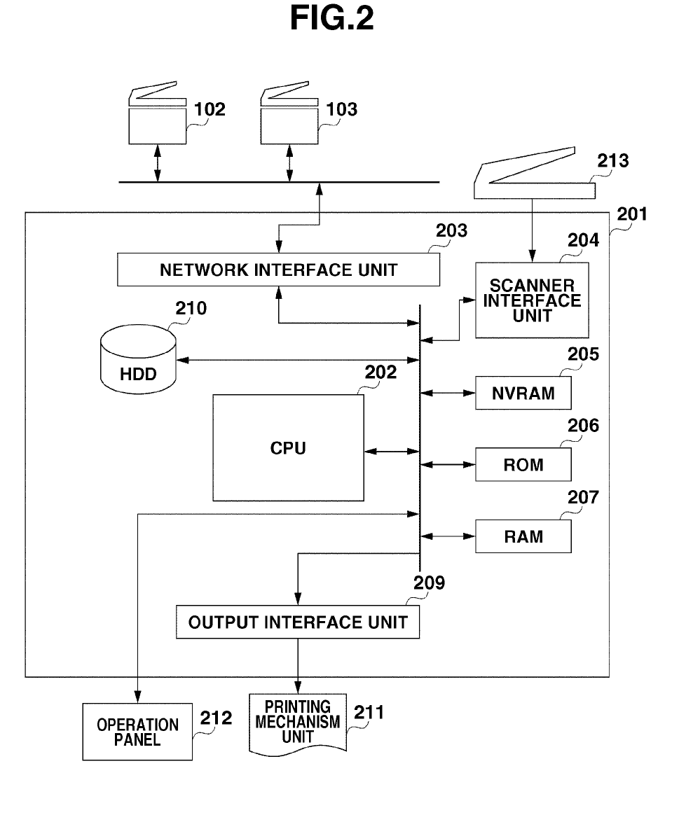

FIG. 2 is a block diagram schematically illustrating a configuration of a control unit of the MFP1 (101) of FIG. 1. A body 201 is the body of a control unit. The other MFP's 102 and 103 are interconnected via a network, and remote copy processing is performed between the MFP's. A scanner unit 213 scans a document.

A network interface unit 203 performs network communication. The PDL data is transmitted/received via the network interface unit 203. The network interface unit 203 can perform encrypted communication with other devices.

An operation panel 212 is an operation interface operated by the user, which enables operation of the other MFP via the network interface unit 203. When instructed to execute copying from the operation panel, the control unit 201 performs image processing by a central processing unit (CPU) 202 regarding a video signal transmitted from the scanner unit 213 via a scanner interface unit 204 in copy processing. The control unit 201 transmits the processed image to a printing mechanism unit 211 via an output interface unit 209 to perform copy processing.

The image processing performed in this case is, for example, conversion of reading resolution of the scanner unit 213 into printing resolution of the printing mechanism unit 211, or rotation processing coinciding with a paper conveying direction of the printing mechanism unit 211.

A hard disk 210 stores a copy image, copy-forgery-inhibited data to be stored, or image data or print data to be registered by the BOX function.

The PDL data received by the host computer is processed by the CPU 202, and converted into dot data. The generated dot data is transmitted to the printing mechanism unit 211 via the output interface unit 209 to be actually printed. The processing performed in this case is, for example, decompression of Huffman-compressed print data.

A series of these processing steps of the CPU 202 are all programmed in a read-only memory (ROM) 206 or the hard disk 210. The CPU 202 operates based on this program.

A random-access memory (RAM) 207 is used as a storage area during processing of the CPU 202. When there is an operation program stored in the hard disk 210, the program is rasterized on the RAM to be executed. The RAM 207 or the hard disk 210 is a storage unit which can be utilized as a predetermined storage area used for a hot folder.

A nonvolatile memory 205 includes a general electrically erasable and programmable read-only memory (EEPROM), and is referred to as a nonvolatile RAM (NVRAM) hereinafter. The NVRAM 205 stores a panel setting value designated by the operation panel 212.

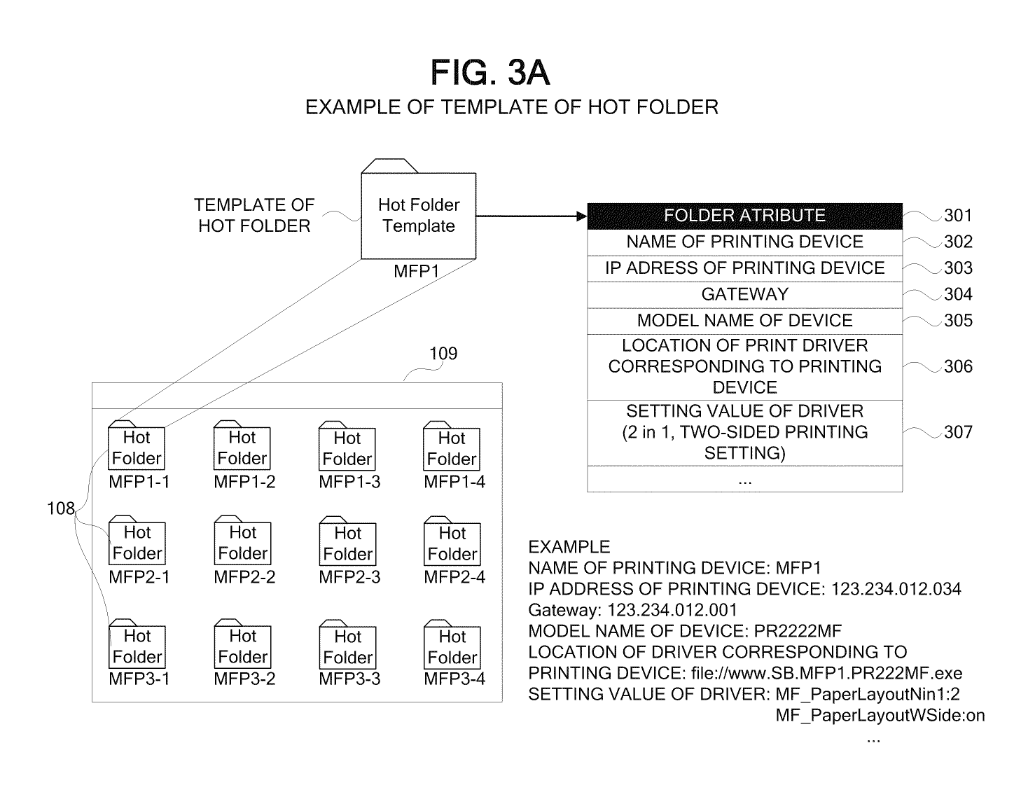

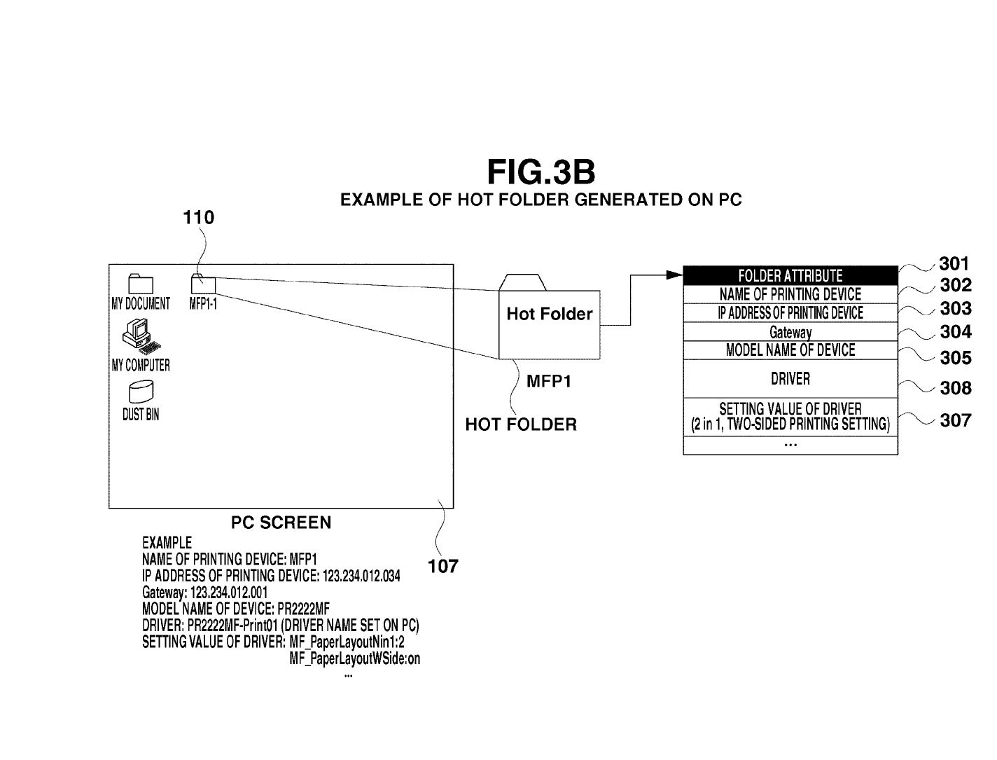

FIG. 3A is a conceptual diagram illustrating attribute information set in the template folder 108. Regarding a template of a hot folder, a plurality of templates may be provided for one printing device. It is because a template folder may have setting information of different drivers for one printing device.

FIG. 3A illustrates a storage status of each attribute information by taking one of template folders 108 in the printing device indicated by the MFP1, as an example.

In the present exemplary embodiment, attribute information (folder attribute) 301 stores a name 302 of a printing device, an IP address 303 of the printing device, gateway 304, a model name 305 of the device, location 306 of a driver corresponding to the device, and a driver setting value 307.

In this case, “MFP1” is stored as a name of a printing device. 123. 234. 012. and 034 are stored as IP addresses of printing devices, and 123. 234. 012. 001 are stored as IP addresses of the gateway of the network. RP2222MF is stored as a model name of the device, and file://www.SB.MFP1.PR2222MF. exe is stored as URL indicating the location of the driver corresponding to the device. “MF_PaperLayoutNin1:2”, and “MF_PaperLayoutWSide:on” are stored as driver setting values.

FIG. 3B illustrates a hot folder 110 generated on the PC 104. In the hot folder 101, attribute information 301 of the printing device such as driver information 308 or driver setting information 307 is associated with a folder. The hot folder 110 is different from the template folder 108 in that there is no information 305 indicating location of a driver while there is driver information 308 indicating which driver is used.

The template folder 108 is copied from the BOX (file server) 105 to the PC 104 to create the hot folder 110. At this time, attribute information is copied as illustrated in FIG. 3B. As a result of copying, an attribute value 305 indicating location of a driver of the template folder is replaced by actually set driver information 308. As a modified example, the attribute value 305 indicating the location of the driver may be left in the folder attribute of the hot folder without being replaced, and the actually set driver information 308 may be added as a new attribute value.

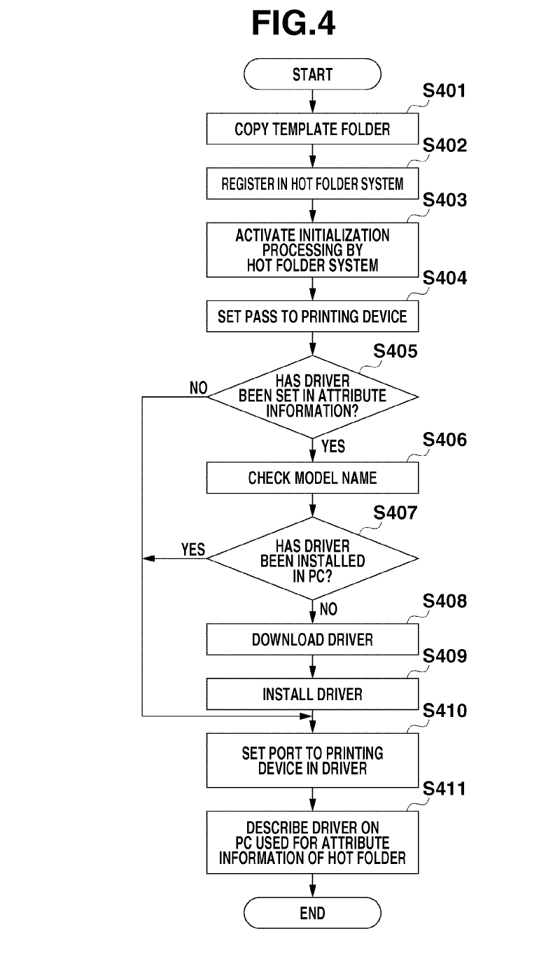

FIG. 4 is a flowchart illustrating a registration (generation) operation of the hot folder 110 on the PC 104, more specifically it is initialization processing when the template folder 108 of the hot folder is copied. The flowchart shows a program operating on the PC, and executed by the CPU of the PC 104 of FIG. 1.

In step S401, the MFP1 (101) of FIG. 1 copies the template folder 108 of the hot holder opened in the BOX (file server) 105 to the PC 104. In this case, the MFP1 copies a folder attribute of the template folder 108 as a folder attribute of a hot folder generated by the PC 104.

The PC 104 registers the copied template folder in the management task of the hot folder. In the present exemplary embodiment, in step S402, the PC 104 registers a directory path (folder path) of a folder in the management task.

In step S403, after the registration of the folder, the management task of the hot folder starts initialization processing.

First, the management task sets an access path to a corresponding printing device by referring to the attribute information of the folder illustrated in FIGS. 3A and 3B. In the present exemplary embodiment, in step S404, the management task registers a name 302 of a printing device to which print data is transmitted, sets an IP address 303 to the printing device and a port for accessing the printing device via the address, and sets a gateway 304 in a network.

In step S405, the management task checks whether driver setting has been described in the attribute information of the folder. The driver setting is information containing at least location 306 of a driver corresponding to the printing device.

If the driver setting has been described (YES in step S405), in step S406, the management task acquires a model name (model type) 305 of the printing device.

In step S407, the management task checks whether a printer driver corresponding to the model name has been set in the PC 104. If a driver designated by the driver setting has not been installed in the PC 104 (NO in step S407), in step S408, the management task downloads a driver from a source in the network. The management task performs the downloading based on information of the location 306 of the driver corresponding to the printing device included in the driver setting.

In step S409, the management task installs a printer driver in the PC 104. In step S410, the management task sets the port leading to the printing device MFP1 set in step 404, to port information of the driver.

In step S411, the management task describes the driver corresponding to the MFP1 in the attribute information of the generated hot folder 110. This processing corresponds to description of the installed printer driver in driver information 308. If a driver used by the PC 104 has been installed, the management task sets a printer port (or checks if the printer port has already been set) and describes driver information in the attribute information. Thus, when the hot folder 110 is generated in the PC 104, setting-up of the printer driver is performed.

Different printer drivers are normally adopted for each of PDL (PCL, and PostScript) and models of printing devices.

As described above, in the present exemplary embodiment, setting of each step is performed based on the folder attribute of the hot folder 110 generated in the PC 104. However, setting of each step may be performed by referring to a folder attribute of a copy source template folder 108 during initialization processing. In this case, the folder attribute of the hot folder 110 is copied from the template, and a folder attribute having driver information 308 described therein is given after driver setting. This attribute information of the hot folder is information used during printing performed using the hot folder.

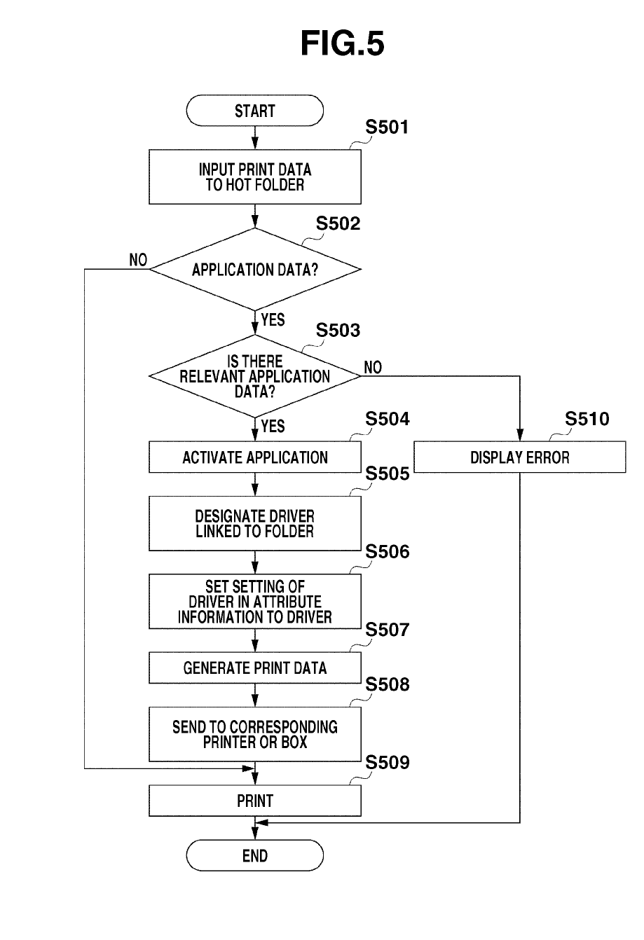

FIG. 5 illustrates an operation of the PC 104 during printing using the hot folder 110. The flowchart is executed as a program in the PC 104. The CPU of the PC 104 in FIG. 1 executes the program.

In step S501, the user stores print data in the hot folder 110. The user performs this processing by dragging and dropping the print data (document file) in the hot folder 110 on the screen of the PC 104.

In step S502, the management task of the hot folder of the PC 104 determines whether the stored print data is application data. If the application data has been stored (YES in step S502), in step S503, the management task checks whether the application has been installed in the PC. If the application is present in the PC (YES in step S503), in step S504, the management task activates the application to perform printing.

In step S505, when activating the application, the management task instructs the application to use a driver 308 designated in the attribute information of the hot folder regarding a driver to be used. Alternatively, the management task temporarily changes a default printer driver used during the application activation.

In step S506, the management task of the PC 104 sets a driver setting item 307 stored in the folder attribute information, to the set driver. In step S507, the management task of the PC 104 converts the stored application data into print data via the application and the driver. In step S508, the management task of the PC 104 transmits the print data to the MFP1 of a printing destination (301, 302) set in the attribute information of the hot folder 110. In step S509, the MFP1 performs printing of the received print data.

Now, a case is described where the print data stored in the hot folder 110 is not application data but print data such as PDL data, image data or PDF data to be directly received and printed by the printing device (NO in step S502). In this case, in step S508, the management task transmits the print data to the MFP1 of the printing destination set in the attribute information of the hot folder 110. In step S509, the MFP1 performs printing.

If there is no application corresponding to the application data stored in the hot folder 110 in the PC (NO in step S503), in step S510, the management task of the PC 104 displays an error to delete the stored application data.

In the processing of step S510, in the present exemplary embodiment, the management task displays an error and deletes the application data. However, the management task may not delete the application data. Further, alternatively setting as to deletion maybe added to the folder attribute 301 of the hot folder 110.

In the present exemplary embodiment, whether printing can be performed is determined at the stage where the application data is stored in the hot folder 110. However, the stage of the determination may be changed to a point of time when the application data is dragged and held on the folder.

### Another Exemplary Embodiment

In the first exemplary embodiment, the template folder 108 of the hot folder is stored in the hard disk of the BOX (file server) 105. In the present exemplary embodiment, however, each printing device includes a template folder.

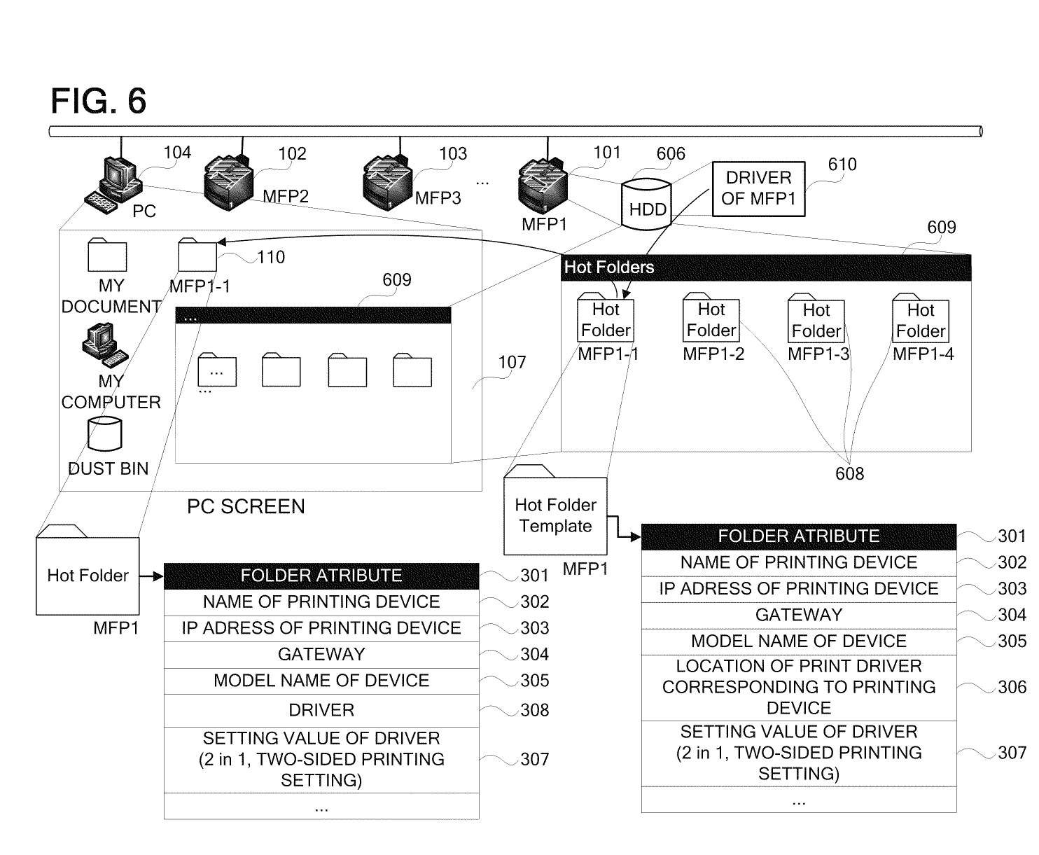

FIG. 6 is a conceptual diagram when a template folder 608 of a hot folder is stored in a MFP1 (101).

Portions similar to those of the first exemplary embodiment are denoted by similar reference numerals of FIG. 1 and FIGS. 3A and 3B. Only differences will be described.

The template folder 608 is a template folder of a hot folder stored in a folder 609 in a hard disk 606 of the MFP1 (101). The folder 609 stores various template folders 608 of hot folders corresponding to the MFP1 (101) stored in the hard disk 606. A difference from the BOX (file server) 105 of FIG. 1 is as follows. In FIG. 1, the BOX 105 stores the template folders 108 of the hot folders of the MFP's (101, 102, and 103). On the other hand, in FIG. 6, the hard disk 606 of the MFP1 (101) stores the template folders 608 of the hot folders of its own MFP1.

There is a plurality of template folders 608 for one printing device (MFP1), because templates of different drivers (for PCL, and PostScript) and different setting values of drivers are prepared.

In the present exemplary embodiment, template folders of hot folders for a MFP2 and a MFP3 (102 and 103) may be provided in the MFP2 and the MFP3 as in the case of the MFP1.

A storage area 610 saves MPF1's own printer driver stored in the hard disk 606 of the MFP1 (101). The printer driver saved in the storage area 610 is downloaded for installation during hot folder creation.

The printer driver is prepared for each type of PDL (PCL or PostScipt).

In the present exemplary embodiment, the user copies the template folder 608 referred to via the PC 104, from the MFP1 to the PC 104 by dragging and dropping the template folder 608 on the screen 107 of the PC, and creates a hot folder 110 with the PC 104.

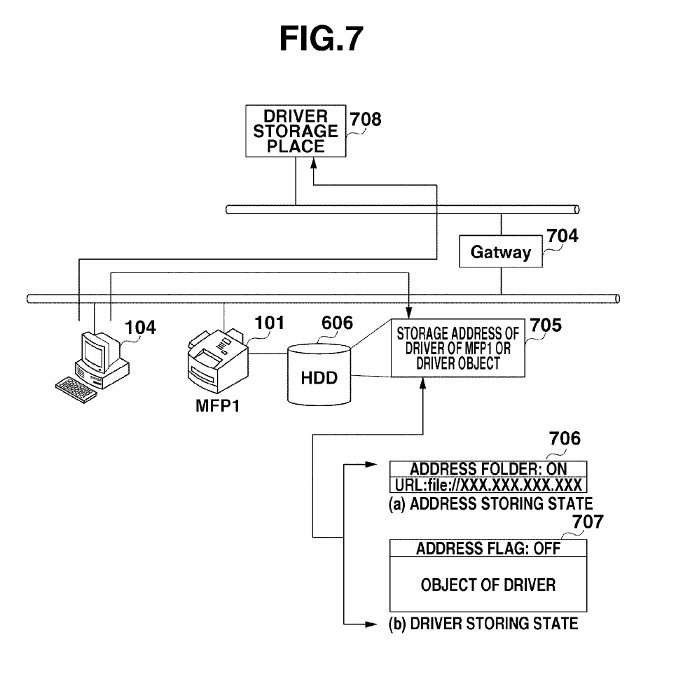

FIG. 7 is a conceptual diagram illustrating a driver downloading procedure and information indicating a storage place of a driver or a storage status of the driver in a case where the storage destination information 306 of the driver described in the attribute information 301 of the hot folder further contains information indicating another storage place.

In FIG. 7, a storage area 705 of a driver stored in the hard disk 606 of the MFP1 (101) which is a printing device saves a storage destination of the driver or the driver itself in forms A and B. In the present exemplary embodiment, an address is stored. There is an address flag indicating storage of the driver itself. Based on the address flag, determination is made. In the form A, a URL indicating a storage place of the driver is stored as a file path address. In the form B, the driver itself is stored.

The management task of the hot folder operating in the PC 104 acquires, during initialization (hot folder creation), the storage destination information 306 of the driver at the time of installing the driver. The management task of the PC 104 accesses the driver storage area 705 of the hard disk 606 to download the driver to the MFP1 (101). In this case, if the address flag is ON 706, it is determined that stored data is an address and the management task downloads the address in the form A. In the present exemplary embodiment, the address of the driver is stored in a URL form in the network.

Then, the management task of the PC 104 accesses a driver storage place 708 storing a driver entity to download the driver based on the address.

Gateway 704 is a router or a computer serving as an entrance to/exit from the driver storage place 708 belonging to a network different the one to which the PC 104 and the MFP1 (101) belong. The gateway 704 is designated by an IP address in gateway information 304 contained in the attribute information 301.

When the PC 104 accesses the driver storage area 705 to download the driver, if the address flag is OFF 707, it is determined that the stored data is a driver entity and the management task downloads the driver in the form B.

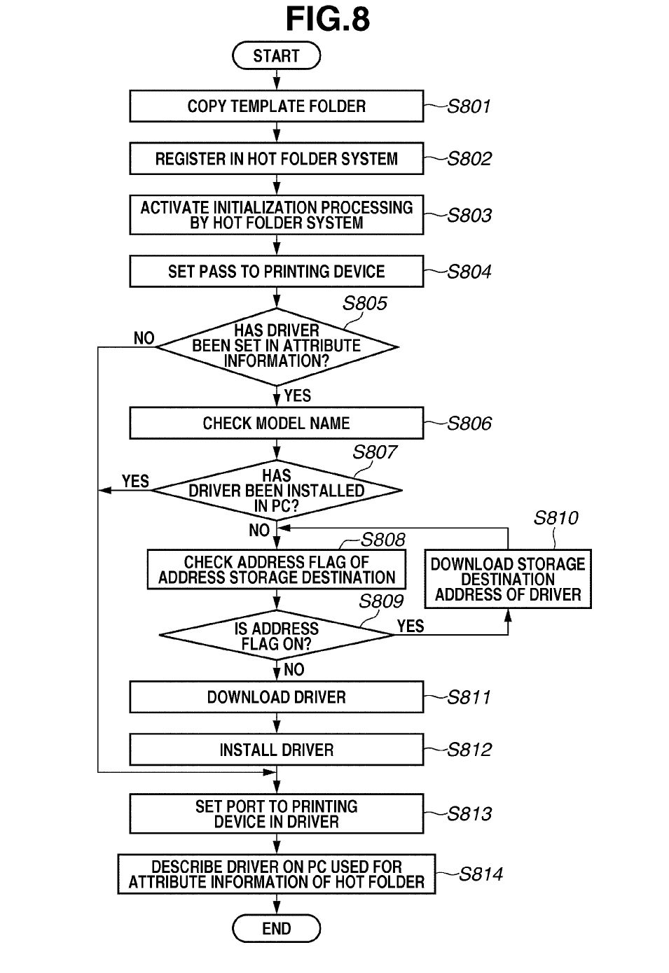

FIG. 8 is a flowchart illustrating a registration operation of a hot folder in the PC 104, more specifically it is initialization processing when a template of a hot folder is copied. The flowchart is a program operating in a PC, which is executed by the CPU of the PC 104.

A difference from FIG. 4 of the first exemplary embodiment is the downloading portions A and B of FIG. 7 using the address flag.

In step S801, the MFP1 (101) of FIG. 1 copies the template folder 108 of the hot folder opened in the BOX 105 to the PC 104, or copies the template folder 608 of the hot folder stored in the hard disk 606 of the MFP1 (101) of FIG. 6. In this case, the folder attribute of the template folder 608 is copied as a folder attribute of the hot folder generated in the PC 104.

The management task of the hot folder registers the copied folder. In the present exemplary embodiment, in step S802, the management task registers a directory path (folder path) of the folder.

In step S803, after the folder registration, the management task of the hot folder starts the initialization processing.

First, referring to the folder attribute information of FIG. 1 (or FIG. 6), the management task sets an access path to a corresponding printing device. In the present exemplary embodiment, in step S804, the management task registers a name 302 of a printing device to which print data is transmitted, sets an IP address 303 to the printing device and a port for accessing the printing device based on the address, and sets a gateway 304 in the network.

In step S805, the management task checks whether driver setting has been described in the folder attribute information. The driver setting is information containing at least location (storage destination) of a driver corresponding to the printing device.

If the driver has been set (YES in step S805), the management task acquires a model name (model type) 305 of the printing device. In step S807, the management task checks whether a printer driver corresponding to the model name has been set in the PC 104.

If a driver designated by the driver setting has not been installed in the PC 104 (NO in step S807), in step S808, the management task accesses a place 705 in the network based on information of the driver storage destination 306 corresponding to the printing device. The management task checks whether an address flag is ON 706 or OFF 707. If the address flag stored in the place 705 is ON (YES in step S809), in step S810, the management task downloads the storage destination address (A of FIG. 7) of the driver.

The management task accesses the address of the driver storage destination to check the address flag until the address flag becomes OFF. More specifically, the management task loops through steps 808 to 810 until the address flag becomes OFF. The present exemplary embodiment shows an example where as a result of accessing the driver storage place 708 based on the downloaded address, a driver storage destination address or a driver entity is stored in the driver storage place 708 as in the case of the forms A and B of FIG. 7. In other words, there is an address flag in the driver storage place 708 and, if the address flag is ON, another place is referred to from the Driver storage place 708.

If the address flag is OFF (No in step S809), in step S811, it is determined that there is a driver entity (form B of FIG. 7) and the management task downloads the driver. In step S812, the management task of the hot folder installs the downloaded driver in the PC 104.

In step S813, the management task sets a port leading to the printing device MFP1 set in step S804, to port information of the driver. In step S814, the management task describes a driver corresponding to the MFP 1 in attribute information of the generated hot folder 110. This processing corresponds to description of the installed printer driver in the driver information 308. If a driver to be used by the PC 104 has been installed, the management task sets a printer port (or checks if printer port has been already set) and describes driver information in the attribute information.

In the present exemplary embodiment, the stored data is divided by using the address flag. However, the stored data may be analyzed and, if a URL has been described, storage of the driver storage destination address may be determined.

In the example of FIG. 8, if not a driver body but a storage destination address of another driver has been stored in a reference destination of the storage destination address of the driver, searching for an address continues until a driver entity is found. Thus, a number of times of tracing addresses by the management task of the CPU 104 may be limited. The number of times is limited for the purpose of preventing a case where reference to addresses cannot be completed, for example, when accessing to addresses is in an infinite loop.

In each of the exemplary embodiments, the user copies the template folders 108 and 608 of the hot folders to create the hot folder 110 in the folder path (directory path) of the PC 104. More specifically, the hot folder is created in the folder path (e.g., in desk top or My Document folder) dragged and dropped by the user. As a modified example, a tool application may be prepared for registering (generating) a hot folder in the management task of the hot folder of the PC 104. In the modified example, during copying of the template folder 108, the user registers the hot folder 110 in the PC 104 by dragging and dropping the template folder 108 onto an icon of the tool application.

In this case, a hot folder generation position (folder path) is preset in the tool application. As a result, the procedure of registering the hot folder generation position in the management task can be omitted.

Various settings can be automatically performed only by copying the template folder of the hot folder and registering the folder, and a hot folder can be easily created in the information processing apparatus (PC).

### OTHER EMBODIMENTS

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-141386 filed Jun. 12, 2009, which is hereby incorporated by reference herein in its entirety.

What is claimed is:

1. An information processing apparatus comprising:
a reference unit configured to refer to a template of a hot folder of an external storage device which stores the template of the hot folder;
an acquisition unit configured to acquire, based on the reference by the reference unit, the template including a folder attribute from the external storage device for the information processing apparatus; and
a generation unit configured to generate, after the acquisition unit has acquired the template for the information processing apparatus, a hot folder for the information processing apparatus,
wherein when the generation unit generates the hot folder, the generation unit generates an attribute of the hot folder corresponding to the folder attribute of the template, and sets up a printer driver in the information processing apparatus based on the attribute of the hot folder.

2. The information processing apparatus according to claim 1, wherein the hot folder generated by the generation unit is a predetermined storage area of a storage unit of the information processing apparatus, and print data is transmitted to a printing device by storing a document in the hot folder.

3. The information processing apparatus according to claim 1, wherein the folder attribute of the template or the attribute of the hot folder includes at least one selected from a name of the printing device, an address of the printing device, a storage destination of a printer driver corresponding to the printing device, and print setting for the printer driver.

4. The information processing apparatus according to claim 3, wherein the generation unit installs the printer driver in the information processing apparatus or sets a port of the printing device for the printer driver based on the storage destination of the storage driver.

5. The information processing apparatus according to claim 4, wherein the storage destination of the printer driver described in the attribute of the hot folder is replaced by the print setting for the printer driver.

6. A method for controlling an information processing apparatus, comprising:
referring to a template of a hot folder of an external storage device which stores the template of the hot folder;
acquiring, based on the reference, the template including a folder attribute from the external storage device for the information processing apparatus; and
generating, after the template has been acquired for the information processing apparatus, a hot folder for the information processing apparatus,
wherein when the hot folder is generated, an attribute of the hot folder corresponding to the folder attribute of the template is generated, and a printer driver is set up in the information processing apparatus based on the attribute of the hot folder.

7. The method for controlling the information processing apparatus according to claim 6, wherein the generated hot folder is a predetermined storage area of a storage unit of the information processing apparatus, and print data is transmitted to a printing device by storing a document in the hot folder.

8. The method for controlling the information processing apparatus according to claim 6, wherein the folder attribute of the template or the attribute of the hot folder includes at least one selected from a name of the printing device, an address of the printing device, a storage destination of a printer driver corresponding to the printing device, and print setting for the printer driver.

9. The method for controlling the information processing apparatus according to claim 8, wherein when the hot folder is generated, the printer driver is installed in the information processing apparatus, or a port of the printing device is set for the printer driver based on the storage destination of the storage driver.

10. The method for controlling the information processing apparatus according to claim 9, wherein the storage destination of the printer driver described in the attribute of the hot folder is replaced by the print setting for the printer driver.

11. A computer-readable storage medium storing a program for executing the method for controlling the information processing apparatus according to claim 6.
